(19) United States
(12) Patent Application Publication
(10) Pub. No.: US 2025/0158013 A1
(43) Pub. Date: May 15, 2025

(54) ONE-SIDED ROLLING INSERTION OF THICK LITHIUM INTO A 3D CURRENT COLLECTOR

(71) Applicant: GM GLOBAL TECHNOLOGY OPERATIONS LLC, Detroit, MI (US)

(72) Inventors: Joel G. TONER, Imlay City, MI (US); Diptak BHATTACHARYA, Royal Oak, MI (US); Caleb REESE, Ferndale, MI (US); Andrew Clay BOBEL, Troy, MI (US); Anil K. SACHDEV, Rochester Hills, MI (US)

(21) Appl. No.: 18/507,783

(22) Filed: Nov. 13, 2023

(51) Int. Cl. H01M 4/04; H01M 4/02; H01M 4/38

(52) U.S. Cl. CPC H01M 4/0435; H01M 4/382; H01M 2004/027

(57) ABSTRACT

A method for manufacturing an electrode for a battery cells includes supplying an active material layer, a current collector, and a dummy current collector between a first roller and a second roller; using one of the first roller and the second roller, biasing the current collector into the active material layer below an outer surface of the active material layer using the dummy current collector; and removing the dummy current collector from the active material layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to current collectors for battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A method for manufacturing an electrode for a battery cells includes supplying an active material layer, a current collector, and a dummy current collector between a first roller and a second roller; using one of the first roller and the second roller, biasing the current collector into the active material layer below an outer surface of the active material layer using the dummy current collector; and removing the dummy current collector from the active material layer.

In other features, the electrode comprises an anode electrode and the active material layer comprises a lithium layer. The lithium layer has a thickness greater than 60 μm. The current collector comprises an anode current collector. The current collector comprises a three dimensional current collector. The current collector comprises a metal mesh. The current collector and the dummy current collector have the same pitch and pattern. After removing the dummy current collector, rolling the active material layer one or more times to enclose the current collector in the active material layer.

In other features, the dummy current collector comprises a substrate and a pattern of raised portions arranged on the substrate. The pattern of raised portions aligns with a pattern of wires of the current collector. The dummy current collector comprises a continuous layer.

A method for manufacturing an electrode for a battery cells includes supplying an active material layer and a current collector between a first roller and a second roller. The first roller includes a pattern of raised portions corresponding to a pattern of wires of the current collector. The method includes using the pattern of raised portions of the first roller to bias the current collector into the active material layer below an outer surface of the active material layer.

In other features, the electrode comprises an anode electrode and the active material layer comprises a lithium layer. The lithium layer has a thickness greater than 60 μm. The current collector comprises an anode current collector. The current collector comprises a three dimensional current collector. The current collector comprises a metal mesh.

In other features, wires of the current collector and the pattern of raised portions have the same pitch and pattern. The method includes rolling the active material layer one or more times to enclose the current collector in the active material layer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell according to the present disclosure;

FIG. 2 is a side view of an example of a method for manufacturing an anode electrode;

FIG. 3 is a side cross sectional view of an example of the anode electrode;

FIG. 4 illustrates an example of a one-sided method for manufacturing an anode electrode;

FIG. 5A is a side cross sectional view of an example of the anode electrode;

FIG. 5B is a plan view of a surface of the anode electrode;

FIGS. 6A and 6B illustrate an example of a one-sided method for manufacturing an anode electrode according to the present disclosure;

FIGS. 7A to 7D are side cross sectional views of an example of an anode electrode during one-sided manufacturing according to the present disclosure; and

FIGS. 8 to 10B illustrate other examples of one-sided methods for manufacturing an anode electrode according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications. While the following description is illustrated by one-sided manufacturing methods for embedding an anode current collector into an active material layer of an anode electrode, the one-sided manufacturing methods can be used to embed a current collector into an active material layer of other types of electrodes.

The present disclosure relates to methods for inserting a current collector such as a three-dimensional current collector (3DCC) into a lithium metal layer such as lithium foil from one side of the lithium metal layer. One advantage of one-sided insertion of the current collector into the lithium layer is that a thicker lithium layer (e.g., greater than 60 μm) can be used. Prior double-sided lamination processes typically use two thinner layers (each less than 50 μm). The thinner layers are more difficult to handle and more expensive to manufacture or purchase. In other words, a lithium layer with a thickness of 60 μm used in the single-sided insertion method is equivalent to two 30 μm lithium layers used for double-sided lamination.

The anode electrodes manufactured using one-sided rolling insertion described herein have a generally symmetric distribution of lithium around the anode current collector. To ensure that the lithium is symmetrically distributed around the anode current collector, a dummy current collector or a surface including a pattern of raised portions is used during the rolling/embedding process to bias the anode current collector into the lithium layer to a location that is spaced from an outer surface of the lithium layer. The lithium will flow into the negative spaces of the patterned counter surface (or “dummy mesh”), which is what enables it to flow beyond the current collector surface. The anode electrode is subsequently pressed and/or heated using a second set of rollers to close gaps and smooth the surface of the lithium layer.

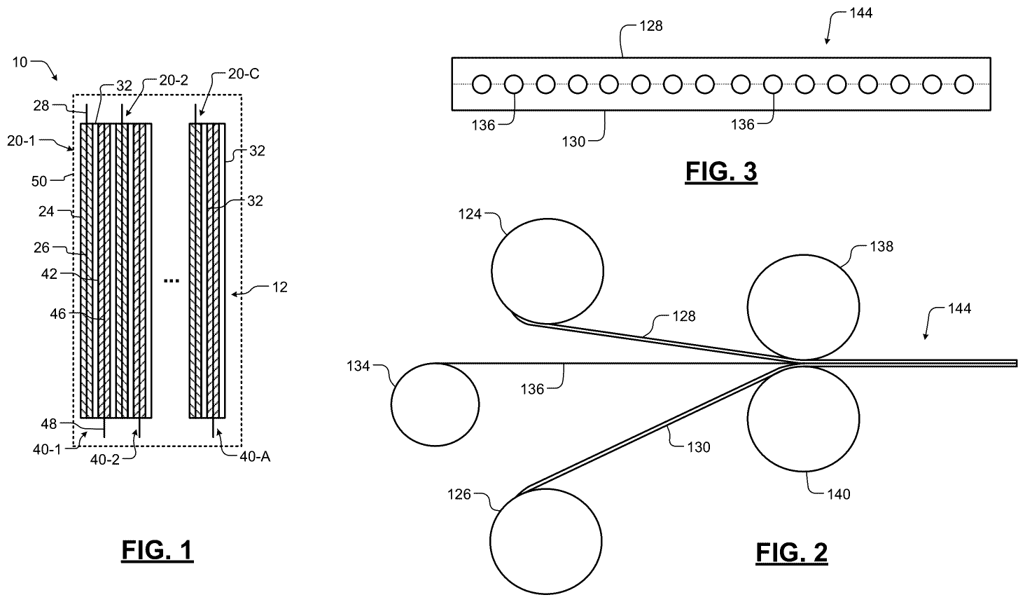

Referring now to FIG. 1, a battery cell 10 includes C cathode electrodes 20, A anode electrodes 40, and S separators 32 arranged in a predetermined sequence in a battery cell stack 12. The battery cell stack 12 is located in an enclosure 50 that includes an electrolyte, where C, S and A are integers greater than zero. The C cathode electrodes 20-1, 20-2, . . . , and 20-C include cathode active material layers 24 arranged on one or both sides of a cathode current collector 26.

In some examples, the A anode electrodes 40 and the C cathode electrodes 20 exchange lithium ions during charging and discharging. The A anode electrodes 40-1, 40-2, . . . , and 40-A include anode active material layers 42 arranged on one or both sides of the anode current collectors 46. In some examples, the cathode active material layers 24 comprise coatings including one or more active materials, one or more conductive additives, and/or one or more binder materials that are applied to the current collectors.

In some examples, the cathode current collector 26 and the anode current collectors 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or opposite sides of the battery cell stack 12. The external tabs 28 and 48 are connected to terminals of the battery cells.

Referring now to FIGS. 2 and 3, a method for manufacturing an anode electrode is shown. In FIG. 2, rollers 124 and 126 supply lithium layers 128 and 130 such as lithium foil between rollers 138 and 140, respectively. A roller 134 supplies an anode current collector 136 between the lithium layers 128 and 130. The rollers 138 and 140 press (and optionally heat) the lithium layer 128, the anode current collector 136 and the lithium layer 130 to form a composite anode electrode. Because the lithium layers 128 and 130 are soft, the anode current collector 136 is pressed into or embedded in abutting surfaces of the lithium layers 128 and 130 as shown in FIG. 3.

Typically, the lithium layers 128 and 130 are thin foil layers having a thickness less than 50 μm (e.g., 30 μm). The composite anode electrode 144 has a thickness in a range from 60 μm to 100 μm. However, the thin lithium foil layers are expensive to manufacture and difficult to handle during roll-to-roll or other types of processing.

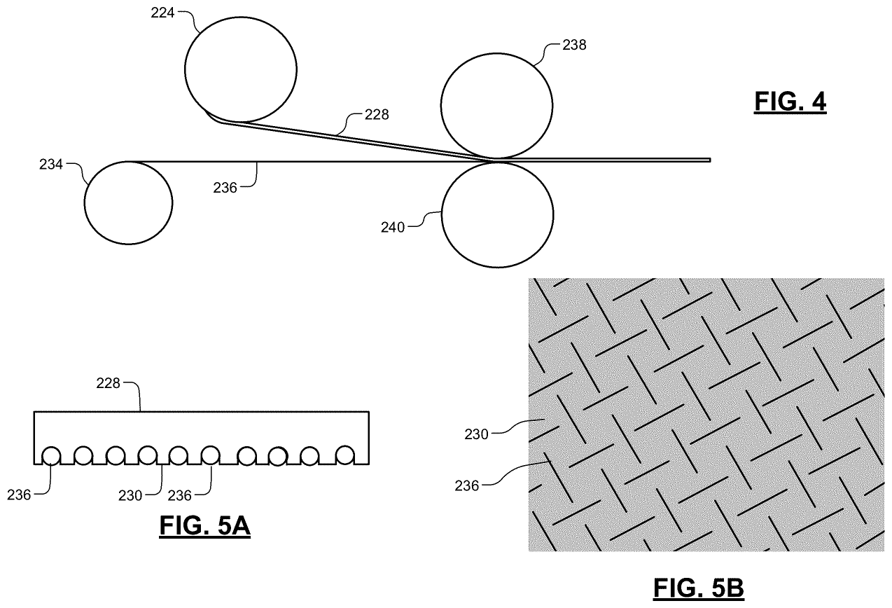

Referring now to FIGS. 4 to 5B, a one-sided method for manufacturing an anode electrode is shown. In FIG. 4, a roller 224 supplies a lithium layer 228 between rollers 238 and 240. A roller 234 supplies an anode current collector 236 adjacent to the lithium layer 228 between rollers 238 and 240. The rollers 238 and 240 press (and optionally heat) the lithium layer 228 and the anode current collector 236. Because the lithium layer 228 is soft, the anode current collector 236 is at least partially pressed into one side of the lithium layer 228 as shown in FIG. 5A. The anode current collector 236 is not located symmetrically near the middle of the lithium layer 228. In FIG. 5B, sides of the anode current collector 236 are exposed on one side of the lithium layer 228.

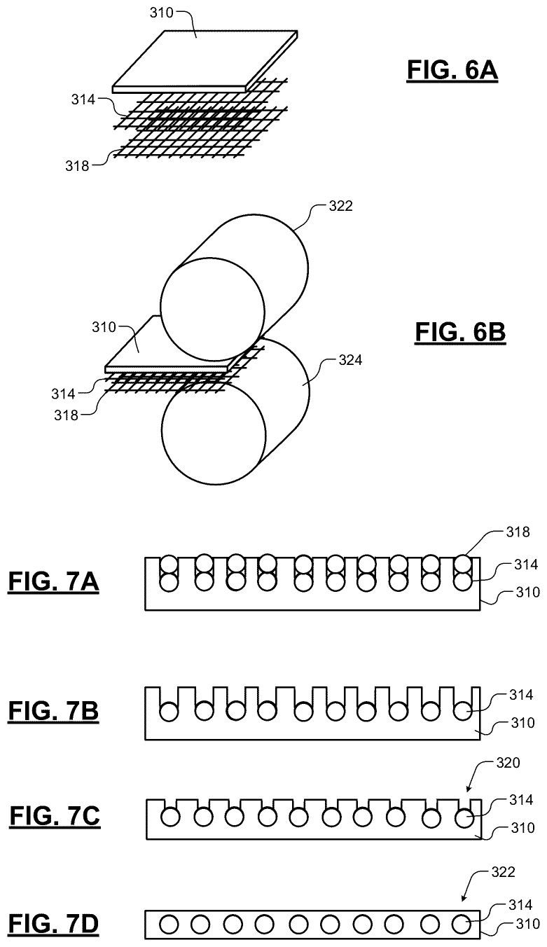

Referring now to FIGS. 6A to 7D, a one-sided method for manufacturing an anode electrode is shown. In FIGS. 6A and 6B, a lithium layer 310, an anode current collector 314, and a dummy current collector 318 are arranged in a stack and pressed (and optionally heated) between rollers 322 and 324. While the lithium layer 310, the anode current collector 314, and the dummy current collector 318 are shown as discrete layers, continuous layers can be used.

In some examples, the dummy current collector 318 is made of the same material and has the same pitch and/or pattern as the anode current collector 314. In other examples, the dummy current collector 318 is made of a different material than the anode current collector 314 and has the same pitch and/or pattern as the anode current collector 314. In other examples, the dummy current collector has a different pitch/pattern than the anode current collector as varying the pattern may be a way to aid lithium flow into the negative spaces.

In FIGS. 6B and 7A, the rollers 322 and 324 press the dummy current collector 318 against the anode current collector 314 to push the anode current collector 314 into the lithium layer 310. In FIG. 7B, the dummy current collector 318 is removed after pressing. In FIG. 7C, the lithium layer 310 and the anode current collector 314 are pressed and/or heated one or more times by one or more additional pairs of rollers to smooth an outer surface of the lithium layer and reduce or remove openings 320 (e.g., as shown at 322 in FIG. 7D).

Since only a single lithium layer is used, the thickness of the lithium layer in some examples can be greater than or equal 60 μm (which is significantly less expensive than the two lithium layers 128 and 130 used in FIGS. 2 and 3 that have a thickness less than 50 μm). The thicker lithium layer is easier to handle due to increased ductility and/or tearing resistance.

In some examples, the lithium layer is arranged symmetrically around the anode current collector after insertion. For example, the anode current collector 136 is located in a range from 45% to 55% of the thickness of the lithium layer 130 after insertion and smoothing of the lithium layer. For example, the anode current collector has a predetermined thickness (e.g., >=60 um) and after symmetric insertion of the anode current collector and subsequent rolling, the anode electrode has a thickness less than or equal to the predetermined thickness.

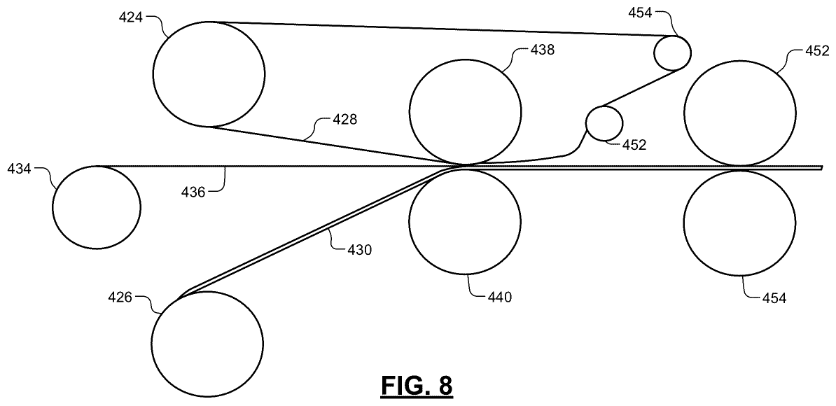

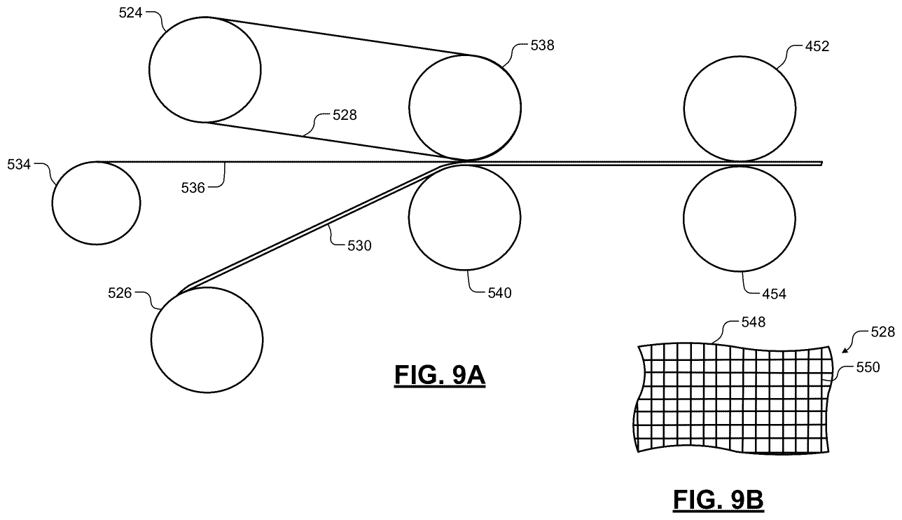

Referring now to FIGS. 8 to 10B, other methods for one-sided manufacturing the anode electrode are shown. In FIG. 8, a method for manufacturing an anode electrode is shown. Roller 424 supplies a dummy current collector 428 as a continuous layer between rollers 438 and 440, respectively. A roller 426 supplies a lithium layer 430 between the rollers 438 and 440, respectively. A roller 434 supplies an anode current collector 436 between the dummy current collector 428 and the lithium layer 430. The rollers 438 and 440 press the dummy current collector 428 into the anode current collector 436 to position the anode current collector 436 below an outer surface of the lithium layer 430. In some examples, the dummy current collector 428 is guided by one or more additional rollers 452 and 454 back to the roller 424.

In FIGS. 9A and 9B, a method for manufacturing an anode electrode is shown. In FIG. 9A, a roller 524 supplies a dummy current collector 528 as a continuous layer between rollers 538 and 540, respectively. A roller 526 supplies a lithium layer 530 between the rollers 538 and 540, respectively. A roller 534 supplies an anode current collector 536 between the dummy current collector 528 and the lithium layer 530. The rollers 538 and 540 press the dummy current collector 528 against the anode current collector 536 to position the anode current collector 536 below an outer surface of the lithium layer 530. In some examples, the dummy current collector 528 is routed around the roller 538 back onto the roller 524.

In some examples, the dummy current collector 528 is made of the same material and has the same pitch and/or pattern as the anode current collector 536. In other examples, the dummy current collector 528 is made of a different material than the anode current collector 536 and has the same pitch and/or pattern as the anode current collector 536. In other examples, the dummy current collector can technically have a different pitch/pattern than the anode current collector as varying the pattern may be a way to aid lithium flow into the negative spaces.

In other examples, the dummy current collector 528 includes a substrate 548 including a pattern of raised portions 550 that have the same wire pattern and pitch and/or pattern as the anode current collector 536 as shown in FIG. 9B. The pattern of raised portions 550 can be made by additive manufacturing, conventional machining, and/or electrodeposition of the patterned layer onto the substrate 548. The pattern of raised portions 550 can be made using polymer, metal, and/or other types of materials that do not plastically deform under rolling pressure (while still being pliable enough to wrap around a rolling surface).

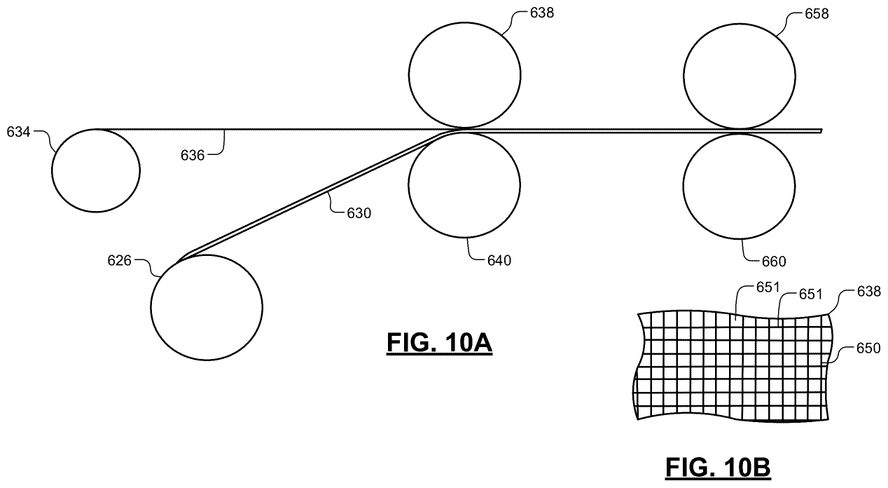

In FIGS. 10A and 10B, a method for manufacturing an anode electrode is shown. In FIG. 10A, a roller 626 supplies a lithium layer 630 between rollers 638 and 640. In some examples, the roller 638 includes a pattern of raised portions 650 (FIG. 10B) and the roller 640 is smooth. A roller 634 supplies an anode current collector 636 between rollers 638 and 640. The rollers 638 and 640 press and/or heat the anode current collector 636 and the lithium layer 630. The pattern of raised portions 650 press the anode current collector 636 into the lithium layer 630. The pattern of raised portions 650 has the same wire pattern and pitch and/or pattern as the anode current collector 636. The anode current collector 636 and the lithium layer 630 are pressed by one or more additional pairs of rollers 658 and 660 to smooth the lithium layer 630.

The pattern of raised portions 650 can be made by additive manufacturing, conventional machining, and/or electrodeposition of the patterned layer onto an outer surface of the roller. The pattern of raised portions 650 can be made using polymer, metal, and/or another material that does not plastically deform under rolling pressure while still being pliable enough to wrap around a rolling surface.

In some examples, the pattern of raised portions 650 (and/or areas therebetween) includes a non-stick coating layer 651 to prevent sticking of the lithium layer to facilitate easier separation of the lithium layer. In some examples, the non-stick coating layer 651 comprises a ceramic coating such as chromium oxide, although other coatings can be used.

In some examples, the pattern of raised portions mimics a pattern of the anode current collector (e.g., a mesh pattern). Additional patterns may be used for current collectors having other patterns such as angled lines, parallel lines, raised circles, and/or truncated cones.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing an electrode for a battery cells, comprising:
supplying an active material layer, a current collector, and a dummy current collector between a first roller and a second roller;
using one of the first roller and the second roller, biasing the current collector into the active material layer below an outer surface of the active material layer using the dummy current collector; and
removing the dummy current collector from the active material layer.

2. The method of claim 1, wherein the electrode comprises an anode electrode and the active material layer comprises a lithium layer.

3. The method of claim 2, wherein the lithium layer has a thickness greater than 60 μm.

4. The method of claim 1, wherein the current collector comprises an anode current collector.

5. The method of claim 2, wherein the current collector comprises a three dimensional current collector.

6. The method of claim 5, wherein the current collector comprises a metal mesh.

7. The method of claim 1, wherein the current collector and the dummy current collector have the same pitch and pattern.

8. The method of claim 1, further comprising, after removing the dummy current collector, rolling the active material layer one or more times to enclose the current collector in the active material layer.

9. The method of claim 1, wherein the dummy current collector comprises a substrate and a pattern of raised portions arranged on the substrate.

10. The method of claim 9, wherein the pattern of raised portions aligns with a pattern of wires of the current collector.

11. The method of claim 9, wherein the dummy current collector comprises a continuous layer.

12. A method for manufacturing an electrode for a battery cells, comprising:
supplying an active material layer and a current collector between a first roller and a second roller,
wherein the first roller includes a pattern of raised portions corresponding to a pattern of wires of the current collector; and
using the pattern of raised portions of the first roller to bias the current collector into the active material layer below an outer surface of the active material layer.

13. The method of claim 12, wherein the electrode comprises an anode electrode and the active material layer comprises a lithium layer.

14. The method of claim 13, wherein the lithium layer has a thickness greater than 60 um.

15. The method of claim 12, wherein the current collector comprises an anode current collector.

16. The method of claim 11, wherein the current collector comprises a three dimensional current collector.

17. The method of claim 16, wherein the current collector comprises a metal mesh.

18. The method of claim 11, wherein wires of the current collector and the pattern of raised portions have the same pitch and pattern.

19. The method of claim 12, further comprising rolling the active material layer one or more times to enclose the current collector in the active material layer.
